(19) United States
(12) Patent Application Publication
(10) Pub. No.: US 2004/0240062 A1
(43) Pub. Date: Dec. 2, 2004

(54) Aluminum oxide produced by flame hydrolysis and doped with divalent metal oxides and aqueous dispersions hereof

(76) Inventors: Wolfgang Lortz, Wachtersbach (DE); Ina Hemme, Hanau (DE); Christoph Batz-Sohn, Hanau (DE); Martin Mortens, Hanau (DE); Herbert Habermann, Biebergemund (DE); Uwe Diener, Grosskrotzenburg (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/486,793

(22) PCT Filed: Sep. 23, 2002
(86) PCT No.: PCT/EP02/10638

(30) Foreign Application Priority Data
Oct. 5, 2001 (DE) 101491301

(51) Int. Cl. G02B 5/18; G02B 27/44

(52) U.S. Cl. 359/566

(57) ABSTRACT

Aluminium oxide doped with a divalent metal oxide, produced by flame hydrolysis and which has no spinell structures or alpha-aluminium detectable in an x-ray diffractogram. It is produced by a pyrogenic process in which, during the flame hydrolysis of aluminium halogenides, an aerosol, which contains an aqueous solution of a divalent metal salt is added to the gas mixture. The doped aluminium oxides can be used in aqueous dispersions for chemical-mechanical polishing.

The invention relates to aluminium oxide produced by flame hydrolysis and doped with divalent metal oxides, aqueous dispersions hereof, their production and use.

Chemical-mechanical polishing, (CMP process) is a technology that is used to planarise surfaces and to produce structures into the submicron range on semi-conductor wafers. For this purpose, dispersions are generally used that have one or more chemically active compounds, at least one abrasive and also a large number of additives capable of changing the properties of the dispersion depending on their desired use.

The abrasive particles which, in the CMP process, should have a high abrasion rate without scratching the surface to be polished, are particularly important. Furthermore, the dispersion should be stable against flocculation and sedimentation of the abrasive particles.

The zeta potential of the abrasive particles in the dispersion plays an important part in this. The particles in a CMP dispersion are electrically charged. This may be due to dissociation of surface groups or desorption or adsorption of ions on the particle surface. Here the electrical charge generally lies not in, but on, the surface of the particle. The zeta potential depends on the type of particle, for example silicon dioxide, aluminium oxide, magnesium oxide, cerium oxide.

An important value connected with the zeta potential is the isoelectric point (IEP). The IEP gives the pH value at which the zeta potential is zero. The IEP is at a pH of ca 9 for aluminium oxide, ca 3.8 for silicon dioxide, and ca 12.4 for magnesium oxide.

The density of the charge on the surface can be influenced by changing the concentration of the potential-determining ions in the surrounding electrolyte. In those dispersions in which the particles carry acid or basic groups on the surface, the charge can be changed by setting the pH value. The potential can further be changed by adding salts or surfactants.

Particles of the same material will possess the same sign of the surface charge and thus repel each other. If the zeta potential is too small, however, the repelling force cannot, compensate for the Waals attraction of the particles and this may result in flocculation or sedimentation of the particles.

With various materials, for example abrasive particles and surfaces to be polished, the surface charge may have a different sign and thus be held onto the surface to be polished. This may result in uneven polishing. Consequently, costly cleaning processes may be required after the polishing step.

As the isoelectric points of the common abrasive particles and the surfaces to be polished are often very far apart (titanium oxide ca 9.5, tungsten ca 1), it is often difficult to set a CMP dispersion in such a way that it is stable and also that no particles adhere to the surface to be polished.

The options described above for influencing the zeta potential are available in principle. However the dispersion must be considered as a whole, with all its components. Thus a shift in the pH value may increase the zeta potential, but at the same time, this may set off the decomposition of the oxidising agent. Furthermore, selectivity may be impaired, in particular with metal polishing. Finally, the additives, which are often represented in the percent range in the CMP dispersions, may themselves enter into reactions.

WO 00/73396 discloses a CMP dispersion containing abrasive particles with the spinell structure MgO.xAl₂O₃, which are obtained by calcination and the zeta potential of which may be changed by varying the magnesium oxide/aluminium oxide ratio.

The disadvantage of this process is the formation of alpha-aluminium oxide, which can cause scratching during polishing. Although stabilisation of the softer gamma-aluminium oxide phase is postulated, this is however proportionately dependent on the content of magnesium oxide. In other words, the higher the magnesium oxide content, the lower the alpha-aluminium oxide formation. As stated in WO 00/73396, even small quantities of alpha-aluminium oxide can, however, lead to scratching during polishing.

Although the formation of alpha-aluminium oxide falls as the magnesium oxide content increases, the BET specific surface area of the particle is also reduced. If a MgO.xAl₂O₃ has a BET specific surface area of 100 m²/g at x=25, at x=1 it is only 40 m²/g, which may restrict its use in CMP dispersions.

This means that a reduction in the alpha-aluminium oxide content goes hand-in-hand with a reduction in the BET specific surface area. The two values cannot be varied independently of each other.

The change in zeta potential with the magnesium content disclosed is not discussed any further. However, it can be concluded from what is said above, that a variation in the zeta potential changes the BET specific surface area and alpha-aluminium oxide content at the same time.

The object of the present invention is to provide abrasive particles in which the zeta potential and BET specific surface area can be varied indpendently of each other and which produce a largely scratch-free surface during polishing.

The invention provides an aluminium oxide doped with a divalent metal oxide, produced by flame hydrolysis and which has no spinell structures or alpha-aluminium oxide detectable in an x-ray diffractogram.

Flame hydrolysis according to the invention is understood to mean the formation of an aluminium oxide doped with a divalent metal oxide in the gas phase in a flame, which is produced by the reaction of a combustion gas and an oxygen-containing gas, preferably air. The reaction of the combustion gas with the oxygen-containing gas produces water vapour, which hydrolyses the precursor substances of aluminium oxide and the divalent metal oxide. Secondary reactions produce the aluminium oxide according to the invention. Suitable combustion gases are hydrogen, methane, ethane, propane, hydrogen being preferred in particular. During flame hydrolysis, highly-disperse, non-porous primary particles are formed first, which can grow together as the reaction progresses to form aggregates, which can further combine to form agglomerates.

The divalent metal oxide according to the invention is the doping component. A dopant is understood to mean a substance which, as a metal component, carries a divalent metal, and which is converted to the oxide during production of the powder according to the invention. The content of the doping component in the aluminium oxide according to the invention relates to the respective oxide.

In contrast to the particles disclosed in WO 0073396 the particles according to the invention have no spinell structures. This may be due to the differing production method. In the pyrogenic process on which the invention is based, no spinell phases are formed, in spite of the high temperatures. The extremely short residence time of the particles at high temperatures which, in a kinetically controlled reaction, produces particles without spinell structures, may be responsible for this. Sputtering experiments using an aluminium oxide doped with magnesium oxide as an example, have also shown that the concentration of the doping component follows a gradient, and thus the highest magnesium oxide concentration was analysed on the surface of the particle.

The BET specific surface area of the doped aluminium oxide, determined to DIN 66131, can be from 1 to 1000 m²/g. Advantageously for CMP applications, the range can be from 50 to 400 m²/g, the range 100 to 250 m²/g being particularly advantageous.

The proportion of doping component in the aluminium oxide according to the invention can be 10 ppm to 5 wt. %. The range 100 ppm to 3 wt. % is preferred, in particular the range can be 0.1 to 2 wt. %.

The doping components can be the divalent metal oxides of magnesium, calcium, zinc, manganese, copper, cobalt or iron.

An aluminium oxide with magnesium oxide as the doping component is preferred in particular.

The invention further relates to a process for the production of the doped aluminium oxide, which is characterised in that a homogeneous gas mixture of a previously vapourised aluminium halogenide and an aerosol is fed into a flame of an oxygen-containing gas and a combustion gas, as used for the production of oxides by the flame hydrolysis method, the gas mixture is allowed to react in the flame and the doped aluminium oxide formed is separated from the gas stream by a known method, the starting material of the aerosol being a solution of a divalent metal salt, and the aerosol being produced by nebulisation using an aerosol generator.

The invention further provides an aqueous dispersion containing the particles according to the invention.

The solid content of the dispersion according to the invention is primarily determined by the intended use. In order to save transport costs, the aim will be to produce a dispersion with as high a solid content as possible, whilst for certain applications, such as for example chemical-mechanical polishing, dispersions with low solid contents are used. A solid content of 0.1 to 70 wt. %, in particular in the range 1 to 30 wt. %, is preferred according to the invention. In this range, the dispersion has good stability.

The size of the aggregates of the aluminium oxide according to the invention in the dispersion can be less than 150 nm. In particular the range can be less than 100 nm.

The aqueous dispersion can have a pH value of 3 to 12. The pH value can be set by acids or bases and serves to increase the stability of the dispersion. Here, the IEP of the particles according to the invention on the one hand, and the stability of other substances in the dispersion, for example the oxidising agent, on the other, must be taken into account.

Inorganic acids, organic acids or mixtures of these can be used as acids.

In particular phosphoric acid, phosphorous acid, nitric acid, sulfuric acid, mixtures thereof and their acid reacting salts can be used as inorganic acids.

Carboxylic acids of the general formula CₙH₂ₙ₊₁CO₂H, where n=0-6 or n=8,10,12, 14, 16, or dicarboxylic acids of the general formula HO₂C(CH₂)ₙCO₂H, where n=0-4, or hydroxycarboxylic acids of the general formula R₁R₂C(OH)CO₂H, where R₁=H, R₂=CH₃, CH₂CO₂H, CH(OH)CO₂H, or phthalic acid or salicylic acid, or acid reacting salts of these acids or mixtures of these acids and their salts are preferred as organic acids.

The pH value can be increased by the addition of ammonia, alkali hydroxides or amines. Ammonia and potassium hydroxide are preferred in particular.

Furthermore, the dispersion according to the invention can contain 0.3 to 20 wt. % of at least one oxidising agent, which can be hydrogen peroxide, a hydrogen peroxide adduct such as for example urea adduct, an organic peracid, an inorganic peracid, an iminoperacid, a persulfate, perborate, percarbonate, oxidising metal salts and/or mixtures of these. Hydrogen peroxide and its adducts are preferred in particular.

As a result of the reduced stability of some oxidising agents in relation to other components of the dispersion according to the invention, it may be useful to add these immediately before the dispersion is used.

Furthermore, the dispersion according to the invention can contain at least one oxidation activator, the purpose of which is to increase the oxidation rate during chemical-mechanical polishing. Suitable oxidation catalysts are the metal salts of Ag, Co, Cr, Cu, Fe, Mo, Mn, Ni, Os, Pd, Ru, Sn, Ti, V and mixtures thereof. Carboxylic acids, nitriles, ureas, amides and esters are also suitable. Iron-II-nitrate is preferred in particular. The concentration of the oxidation catalyst can be varied in a range of 0.001 to 2 wt. % depending on the oxidising agent and polishing task. In particular the range can be from 0.01 to 0.05 wt. %.

The dispersion according to the invention can further contain 0.001 to 2 wt. % of at least one corrosion inhibitor. Suitable inhibitors encompass the group of nitrogen-containing heterocyclics such as benzotriazol, substituted benzimidazols, substituted pyrazines, substituted pyrazoles, glycine and mixtures thereof.

In order to stabilise the dispersion further, for example against deposition of the abrasive, flocculation and decomposition of the oxidising agent, 0.001 to 10 wt. % of at least one surfactant substance of a non-ionic, cationic, anionic or amphoteric type, can be added to it.

The invention further provides a process for the production of the dispersion with dispersing and/or milling devices, which produce an energy input of at least 200 KJ/m³. These include systems according to the rotor-stator principle, for example Ultra-Turrax machines, or mechanically agitated ball mills. Higher energy charges are possible with a planetary kneader/mixer. However, the effectiveness of this system depends on the mixture processed having a sufficiently high viscosity to incorporate the high shear energies required to disperse the particles.

High-pressure homogenisers can be used to obtain aqueous dispersions in which the aluminium oxide according to the invention can be less than 150 nm, and preferably less than 100 nm.

With these devices, two pre-dispersed suspension streams under high pressure are released through a nozzle. The two dispersion jets collide with each other exactly and the particles mill themselves. In another embodiment, the pre-dispersion is also placed under high pressure, but the collision of the particles takes place against armoured wall areas. The operation can be repeated as often as desired to obtain smaller particles.

The invention further provides the use of the dispersion according to the invention for the chemical-mechanical polishing of metallic and non-metallic surfaces. The good stability of the dispersion according to the invention over a broad pH range makes it possible, for example, to polish aluminium, aluminium alloys, copper, copper alloys, tungsten, titanium, tantalum, silicon nitride, titanium nitride, tantalum nitride.

Furthermore, the dispersions according to the invention is suitable for the production of very fine-particle surface coatings in the paper industry or for the production of special types of glass.

### EXAMPLES

Analysis Process

The BET-surface of the powders used was determined according to DIN 66131.

The viscosity of the dispersions is determined with a Physica MCR 300 rotation rheometer and CC 27 measuring beaker. The viscosity value is determined at a shearing rate of 100 s⁻¹. This shearing rate is in a range in which the viscosity is practically independent of the shearing load.

The zeta potential is determined with a DT-1200 device from Dispersion Technology Inc, using the CVI process.

The aggregate size in the dispersion is determined by dynamic light scattering. The zetasizer 3000 Hsa (Malvern Instruments, UK) is used. The volume- and number-weighted median values of the peak analysis are given.

Powder Production

### Example 1

1.31 kg/h AlCl₃ are evaporated at ca 130° C. and transferred to the central tube of the burner. 0.538 Nm³/h (primary hydrogen), 1.35 Nm³/h air and 0.43 Nm³/h inert gas (N₂) are also fed into the central tube. The gas mixture flows out of the inner nozzle of the burner and burns in the combustion chamber and the water-cooled flame tube attached to it. 0.05 Nm³/h (shell- or secondary-) hydrogen is fed into the the shell nozzle surrounding the central nozzle to avoid baked-on deposits on the nozzles. An additional 20 Nm³/h secondary air is fed into the combustion chamber.

The second gas component flows from the axial tube into the central tube. The second gas stream consists of an aerosol charged with a magnesium salt. This magnesium salt aerosol is produced by nebulisation from a 15% aqueous magnesium nitrate solution in an aerosol generator. 71.6 g/h magnesium salt solution are atomised. This nebulised magnesium salt solution is fed through heated pipes using a carrier gas of 1.0 Nm³/h air, the salt vapour mist being converted to gas and salt crystal aerosol at temperatures of ca 180°. The temperature of the gas mixture (AlCl₃-air-hydrogen, aerosol) is measured at the burner mouth; it is 295° C.

After flame hydrolysis, the reaction gases and the aluminium oxide doped with magnesium that is formed are sucked through a cooling system by applying negative pressure and the particle gas stream is thus cooled to ca 100 to 160° C. The solid is separated from the waste gas stream in a filter or cyclone.

The aluminium oxide doped with magnesium is deposited as a white, fine-particle powder. In a further step, any hydrochloric acid residues still adhering to the particles are removed at high temperature by treatment with air containing water vapour.

Examples 2 to 7 are carried out in the same way as example 1. the parameters are given in Table 1.

Production of the Dispersion

Method A: 29.0 kg DI water and 25 g 100% acetic acid (“glacial acetic acid”) are added to a 60 l special steel charge container. 4.38 kg of the particles from example 5 are sucked in and roughly pre-dispersed using an Ystrahl dispersion and suction mixer (at 4500 rpm). During powder intake, a pH value of 4.5+−0.3 is maintained by the addition of acetic acid. After powder intake, dispersion is completed using an Ystrahl Z 66 rotor/stator throughput homogeniser with four processing rings, a stator slit width of 1 mm and a speed of 11 500 rpm. Before rotor/stator dispersal, a pH value of 4.5 is set by adding more acetic acid and this has not changed even after 15 minutes' dispersal at 11 500 rpm. With the 25 g acetic acid provided, 389 g were used in all. An abrasive body concentration of 12.5 wt. % is set (dispersion 8A) by adding 1.24 kg water.

Method B: Approximately half of the dispersion from method A is milled with a high pressure homogenizer, Ultimaizer System from Sugino Machine Ltd., model HJP-25050, at a pressure of 250 Mpa, a diamond nozzle diameter of 0.3 mm and two passes through the mill (dispersion BB).

Similarly dispersions 9A and 9B are produced with the particles from example 6 and dispersions 10A and 10B with the particles from example 7.

The particles from example 6 are used with the same dispersion method to produce dispersions 11A and 11B with an abrasive body concentration of 30 wt. %. 874 g acetic acid were required to set the pH value of 4.5.

Dispersions of aluminium oxide (Alu C, Degussa AG) (dispersions 12A and 12B) are used for comparison.

The analytical data of the dispersions are shown in Table 2.

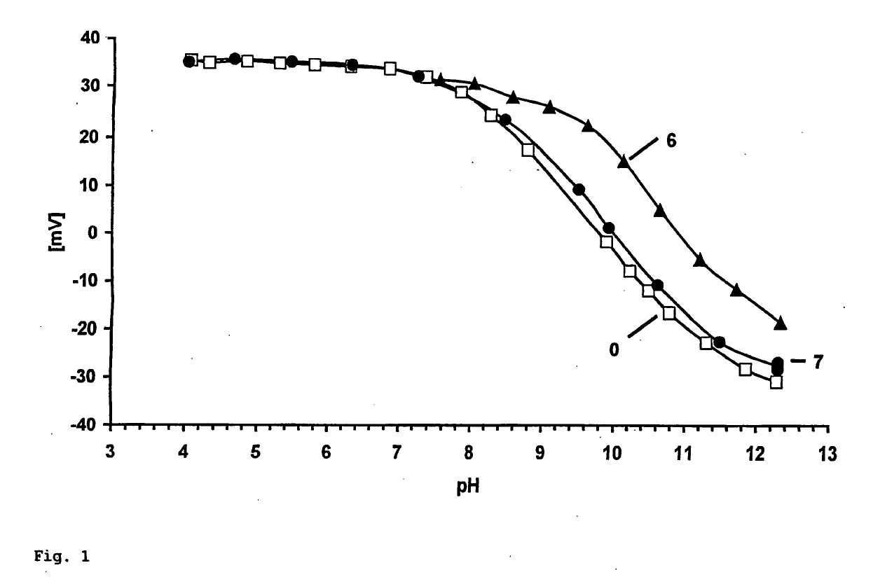

FIG. 1 shows the course of the zeta potential of the powders according to examples 6 and 7 of the invention in comparison with undoped aluminium oxide designated 0 (Alu C, Degussa AG). The value of the zeta potential depends only slightly on the proportion of the doping component in the aluminium oxide according to the invention. However the IEP can be shifted to higher pH values by increasing the content of the doping component. This means that tailor-made particles with a defined IEP can be produced and thus the application range of the dispersion can be extended without having to re-optimise the numerous other components in a CMP dispersion.

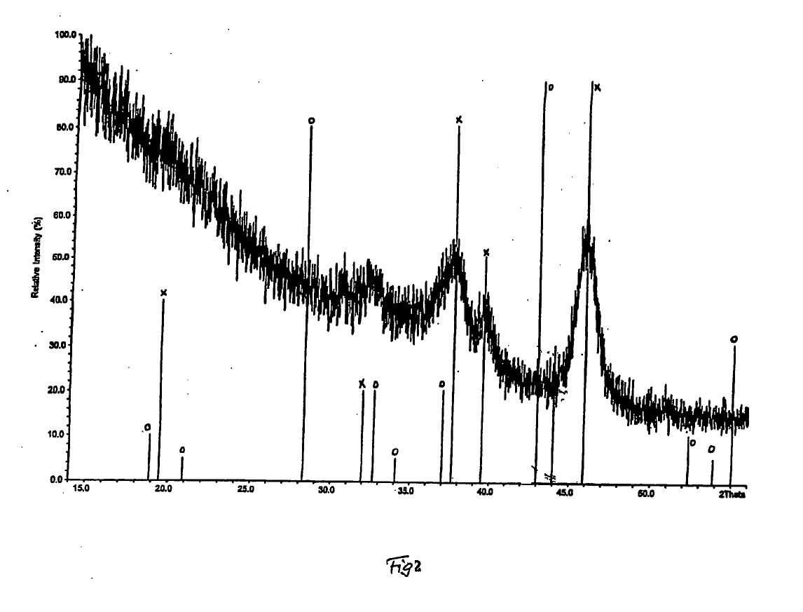

FIG. 2 shows the x-ray diffractogram of the powder according to example 6 of the invention. Reflexes of MgAl₂O₄ (spinell), designated “o” in the diffractogram, cannot be detected. The reflexes of the powder according to the invention are substantially identical to those of gamma-aluminium oxide, designated “x” in the diffractogram. The powder according to the invention shows no reflexes of alpha-aluminium oxide.

Polishing Trials

Polishing Dispersions

The dispersions of examples BB, 9B, 10B and 12B are diluted with DI water to an abrasive particle content of 5 wt. % for polishing purposes. 1.3 wt. % glycine and 7.5 wt. % hydrogen peroxide are then added.

Polishing Tool and Polishing Parameters

Polishing machine: MECAPOL E460 (STEAG) with 46 cm platen and 6″ wafer carrier

Polishing pad: IC1400 (RODEL Corp)

Pad conditioning with diamond segment after each polished wafer

Slurry quantity: 120 ml/min for all trials

Polishing parameters: pA working pressure 10 to 125 kPa

Standard 45 and 60 kPa

pR Back pressure 10 kPa

ωₚ=ω_{c}=40 rpm (for all trials)

Sweep=4 cm (for all trials)

Polishing time: 2 min

After-cleaning: After polishing, the wafer is rinsed with DI water for 30 s and then cleaned on both sides and spun dry in a brush cleaning unit with spray jet and megasonic support.

Wafer Preparation

Cu: 6″ Wafer with 140 nm oxide, 50 nm TaN and ca 500 or 1000 nm PVD-Cu over entire surface.

Polishing Results

Tab. 3 shows the polishing results. In comparison with polishing dispersion 16, dispersions 13 to 15 according to the invention have slightly lower copper abrasion rates irrespective of the working pressure, but have better non-uniformity.

TABLE 1
Experimental conditions for the production of doped aluminium oxide and
characteristics of the particles obtained

| | | | | | | | | BET-spec. |
|---|---|---|---|---|---|---|---|---|
| | | Gas | | Precursor | Precursor | Solution | Mg- | Surface |
| Example | AlCl₃ | Temp. | Mg- | concentration | nebulised | nebulised | content | area |
| no. | kg/h | ° C. | Precursor | Gew.-% | g/h | g/h | wt. % | m²/g |
| 1 | 1.31 | 295 | Mg(NO₃)₂ | 15 | 10.7 | 71.6 | 0.582 | 110 |
| 2 | 1.31 | 300 | Mg(NO₃)₂ | 15 | 11.3 | 75.0 | 0.610 | 53 |
| 3 | 1.31 | 287 | Mg(NO₃)₂ | 15 | 11.0 | 73.7 | 0.599 | 180 |
| 4 | 0.656 | 291 | Mg(NO₃)₂ | 15 | 11.1 | 73.8 | 1.20 | 186 |
| 5 | 1.31 | 296 | MgCl₂ | 5 | 3.0 | 59.9 | 0.253 | 105 |
| 6 | 0.656 | 294 | Mg(NO₃)₂ | 15 | 11.2 | 74.0 | 1.13 | 101 |
| 7 | 1.31 | 291 | Mg(NO₃)₂ | 5 | 2.03 | 26.1 | 0.11 | 118 |

H₂ core: 0.538 Nm³/h; H₂ shell: 0.05 Nm³/h;
N₂ core: 0.43 Nm³/h; N₂ shell: 0.10 Nm³/h;
Carrier gas nebuliser: 1 Nm³/h

TABLE 2
Analytical data for the dispersions

| | Powder | | Content MgO- | | | |
|---|---|---|---|---|---|---|
| | from | Dispersion | doped Al₂O₃ | Ø (Number) | Ø (Volume) | Viscosity |
| Example | example | method | [wt. %] | [nm]⁽¹⁾ | [nm]⁽²⁾ | [mPas] |
| 8A | 5 | A | 12.5 | 61 | 108 | 3 |
| 8B | 5 | B | 12.5 | 58 | 73 | 2 |
| 9A | 6 | A | 12.5 | 61 | 109 | 3 |
| 9B | 6 | B | 12.5 | 58 | 74 | 2 |
| 10A | 7 | A | 12.5 | 59 | 106 | 3 |
| 10B | 7 | B | 12.5 | 56 | 71 | 2 |
| 11A | 6 | A | 30 | 57 | 101 | 15 |
| 11B | 6 | B | 30 | 43 | 66 | 7 |
| 12A | Alu C | A | 12.5 | 78 | 133 | 3 |
| 12B | Alu C | B | 12.5 | 57 | 79 | 2 |

⁽¹⁾Average particle diameter (number);
⁽²⁾Average particle diameter (volume)

TABLE 3
Polishing results

| | Dispersion | Abrasion | Abrasion | Non- | Non- |
|---|---|---|---|---|---|
| Ex- | from | nm Cu/min | nm Cu/min | uniformity | uniformity |
| ample | example | at 45 kPa | at 60 kPa | at 45 kPa | at 60 kPa |
| 13 | 8B | 148 | 186 | 3.4 | 4.3 |
| 14 | 9B | 155 | 191 | 4.1 | 5.5 |
| 15 | 10B | 142 | 180 | 4.3 | 6.1 |
| 16 | 12B | 164 | 205 | 5.3 | 7.7 |

1. Aluminium oxide doped with a divalent metal oxide, produced by flame hydrolysis which has no spinell structures or alpha-aluminium oxide detectable in an x-ray diffractogram.

2. The aluminium oxide according to claim 1, having a BET specific surface area of 1 to 1000 m²/g.

3. The aluminium oxide according to claim 1, wherein the divalent metal oxide is present in an amount of 10 ppm to 5 wt. %.

4. The aluminium oxide according to claim 1, wherein the divalent metal oxide is at least one of magnesium oxide, calcium oxide, zinc oxide, manganese oxide, copper oxide, cobalt oxide or iron oxide.

5. A process for the production of the aluminium oxide according to claim 1, comprising
feeding a homogeneous gas mixture of a vaporised aluminium halogenide and an aerosol into a flame of an oxygen-containing gas and a combustion gas,
reacting the gas mixture in the flame to form doped aluminium oxide and
separating the doped aluminium oxide from the gas stream, wherein the aerosol is derived from a solution of a divalent metal salt, that is nebulized with an aerosol generator.

6. An aqueous dispersion comprising the aluminium oxide according to claim 1.

7. The aqueous dispersion according to claim 6, wherein the content of the doped aluminium oxide in the dispersion is 0.1 to 70 wt. % in relation to the whole dispersion.

8. The aqueous dispersion according to claim 6, wherein the average particle size of the doped aluminium oxide is smaller than 150 nm.

9. The aqueous dispersion according to claim 6, having a pH value of 3 to 12.

10. The aqueous dispersion according to claim 6, further comprising from 0.3 to 20 wt. %, in relation to the whole dispersion of at least one oxidising agent.

11. The aqueous dispersion according to claim 6, further comprising from 0.001 to 2 wt. %, in relation to the whole dispersion, of at least one oxidation activator.

12. The aqueous dispersion according to claim 6, further comprising from 0.001 to 2 wt. %, in relation to the whole dispersion, of at least one corrosion inhibitor.

13. The aqueous dispersion according to claim 6, further comprising from 0.001 to 10 wt. %, in relation to the whole dispersion, of at least one surfactant substance.

14. A process for the production of the aqueous dispersion according to claim 6, comprising
dispersing the doped aluminium oxide in an aqueous medium with an energy input of at least 200 KJ/m³.

15. The process according to claim 14, further comprising
milling and dispersing the doped, metal oxide particles in an aqueous medium, by dispersing the particles under a pressure of up to 3500 kg/cm², and releasing the particles through a nozzle to collide with each other or with wall areas of a device.

16-17. (Canceled).

18. A method for chemically mechanically polishing a metallic or a non-metallic surface comprising:
contacting the metallic or the non-metallic surface with the aluminium oxide of claim 1 and
polishing the metallic or non-metallic surface.

19. A surface coating comprising the aluminium oxide of claim 1.

20. A glass comprising the aluminium oxide of claim 1.
